(19) United States
(12) Patent Application Publication
(10) Pub. No.: US 2011/0128101 A1
(43) Pub. Date: Jun. 2, 2011

(54) Computing device power supply interrupter

(76) Inventors: Chris Allen Smock, Indianapolis, IN (US); L.E. Pauli Coffey, Indianapolis, IN (US)

(21) Appl. No.: 12/925,716

(22) Filed: Oct. 28, 2010

Related U.S. Application Data
(60) Provisional application No. 61/263,012, filed on Nov. 20, 2009.

(51) Int. Cl. H01H 50/54

(52) U.S. Cl. 335/2

(57) ABSTRACT

This device, either applied as an aftermarket unit to an existing power supply source for a computing device, or as a single piece, factory created unit, will automatically stop all current draw from a power supply [port] when a computing device is disconnected at its charging connection at the port end without the need to be unplugged from a main power source. This one simple device will stop the waste of electricity and, therefore, stop the waste of precious natural resources.

### BACK GROUND OF THIS INVENTION

This invention is for the purpose of preventing the waste of electricity, and the vital resources used to create and produce electricity, caused by portable computing device powers supplies when not in use but still plugged into a power supply [port] of any kind including but not limited to, a standard wall electricity outlet or vehicle data power port.

An example of such a device is the Toshiba Satellite A305-S6905 laptop computer. This particular computing device can be charged via a hard wire electricity wall port or vehicle charging port. At the point that the Toshiba Satellite Laptop computer device is fully charged it is often the circumstance that the device is unplugged at the device end charging point for the purpose of mobility, and the charging system is left in-place to continue to pull power from the main source even when connected to nothing. An inarguable example of the damage caused by this circumstance has been the instance, on well more than one occasion, of a dead car battery and the crisis of undue, increased electricity use in both home and office settings.

### SUMMARY OF THE INVENTION

According to a typical embodiment of the present invention, the power supply cut-off switch is fitted between the computing device charging circuit and the power source. Cabling will extend from the power supply cut-off switch to the activation switch located on the computing device charging point. Power for the power supply cut-off switch and activation switch will be supplied from the same power source as the computing device power supply.

### BRIEF DESCRIPTION OF DRAWINGS

FIG. 1: Is a schematic drawing of the entire system when used as an add-on configuration. In this configuration, a plug in wall box is used to contain a relay with a 110 VAC coil and DPDT contacts. The relay in figure A is shown in its normally open position. The output of the relay goes to a 110/115 VAC receptacle that the charging power supply is plugged into. This device can be reconfigured to include but not limited to, vehicle or other charging ports via the installation of a 5V, 12V, 24V, or any other voltage rated relay necessary to power any computing device. The relay coil is connected by a two conductor cable to a normally open switch that can be attached in varying, different ways including but not limited to a split loom, insulating sheathing, two way tape, nylon wire tie, Velcro, or any chemical bonding agent to the power supply plug for the computing device at the computing device end.

When disconnected from the computing device, the switch will automatically open. Thereby, releasing the relay and dropping all current draw from any given charging power supply.

FIG. 2: Is a schematic drawing of the entire system when used in a factory integrated configuration. In this configuration, the relay is integrated into the computing device charging power supply or in a separate box in the power supply power source line. The relay has a 110 VAC coil and DPDT contacts. The device can be reconfigured to include all other power and data ports utilized to provide power to computing devices. The relay in figure B is shown in its normally open position. The input to the relay is directed off of the 110/115 VAC or other voltage contacts. The output of the relay then goes to the charging circuit of the power supply. The coil of the relay is connected via a two conductor cable to a normally open switch that can be connected in various different ways including but not limited to, an industry standard insulation jacket or any other chemical bonding agent.

When disconnected from the computing device the switch will automatically open, thereby releasing the relay and dropping all current draw from any given power supply source or [port].

### DESCRIPTION OF THE PREFERRED EMBODIMENT

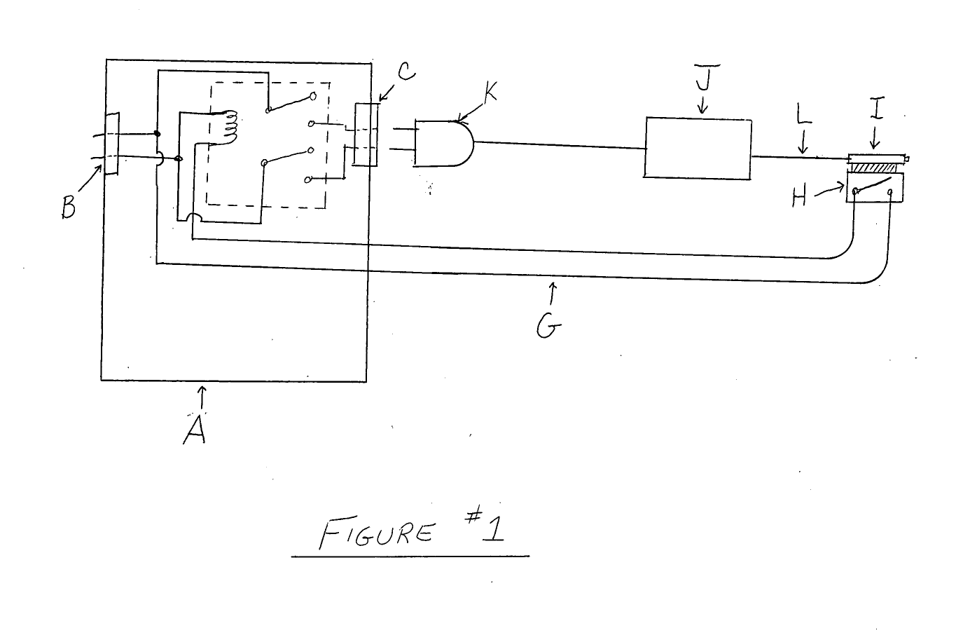

FIG. 1: Is comprised of a standard plastic case (1), with a polarized 120 VAC male plug (2) and a 120 VAC female receptacle (3). Within the plastic case is contained a relay (4). The relay has a 110 VAC coil (5) and DPDT contacts (6) rated at 3 amps/125 VAC, though ratings, as determined by a nationally recognized testing laboratory, would be acceptable as determined by electrical load. This device has a two conductor cable (7) exiting through the side of the plastic case and extending to the activation switch (8) connected to the computing device charging port.

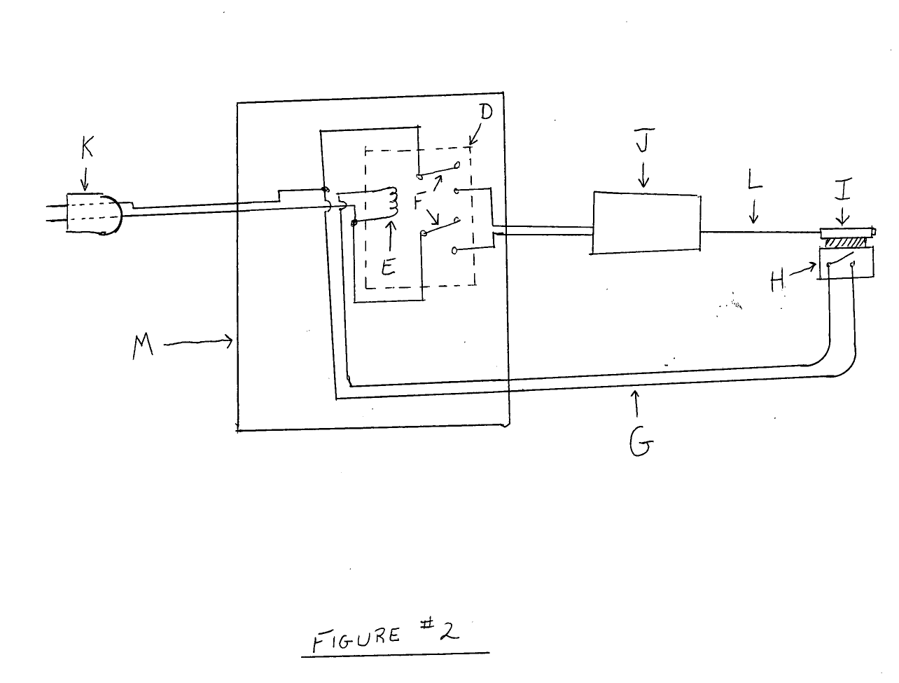

FIG. 2: Is comprised of a relay (9) with a 110 VAC coil (10) and DPDT Contacts (11) in a factory made charger, rated at 3 amps/125 VAC, though ratings as determined by a nationally recognized testing laboratory, would be acceptable, as determined by load A two conductor cable (12) extends from the relay to the activation switch (13) connected to the computing device charging port.

FIG. 1:

A.) Housing non-metallic

B.) Fixed 120 VAC male connector

C.) Fixed 120 VAC female connector

D.) Relay with DPDT contacts and 120 VAC coil

E.) 120 VAC coil

F.) DPDT Contacts

G.) One (1) two conductor control cable attached to the computing device charging cable

H.) Normally open switch attached to the computing device charging plug

I.) Computing charging device plug

J.) Computing device power supply

K.) 120 VAC connector

L.) Computing device charging cable

FIG. 2:

A.) (not used in FIG. 2)

B.) (not used in FIG. 2)

C.) (not used in FIG. 2)

D.) Relay with DPDT contacts and 120 VAC coil

E.) 120 VAC Coil

F.) DPDT contacts

G.) One (1) two conductor cable attached to, or integrated with, the computing device charging cables.

H.) Normally open switch attached to or integrated with the computing device charging plug

I.) Computing device charging plug

J.) Computing device power supply

K.) 120 VAC power source connector

L.) Computing device charging plug

M.) Box containing relay. [Relay could be integrated directly into power supply source]

What is claimed is:

1. A power supply interrupter as an “after market” or secondary attachment connected to a power supply for a computing device comprising:

2. A standard plastic case with a polarized 120 VAC male plug and a 120 VAC female receptacle.

3. Within the plastic case is contained a relay with a 110 VAC coil and DPDT contacts rated at 3 amps/125 VAC.

4. Many other ratings, as determined by a nationally recognized laboratory, would be acceptable as determined by electrical load.

5. This device has a two conductor cable exiting through the side of the plastic case and extending to the activation switch connected to the computing device charging [port].

6. This device can be connected to any existing power supply via Velcro, two way tape, split loom, insulating jacket, nylon wire tie or any other chemical bonding agent.

7. The device in claim 1 does stop all current draw from any given power supply [port] when not physically plugged into the computing device charging point.

8. Power for the power supply cut-off switch and activation switch will be supplied from the same power source as the computing device power supply.
B. A factory integrated, power supply interrupter device comprising:

9. A relay with a 110 VAC coil and DPDT contacts rated at 3 amps/125 VAC.

10. Many other ratings, as determined by a nationally recognized laboratory, would be acceptable, as determined by electrical load.

12. This device has a two conductor cable that extends from the relay to the activation switch connected to the computing device charging port.

13. This device is a single piece, factory made unit.

14. The device in claim 2 does interrupt all current draw from any given power supply [port] when not plugged into the computing device charging point.

15. In this configuration the relay is integrated into the computing device charging power supply or in a separate containment unit in the power supply source line.

16. The input to the relay is directed off of the 110/115 VAC or other voltage contacts as dictated above.

17. The output of the relay then goes to the charging circuit of the power supply [port].
